(19) United States
(12) Patent Application Publication
(10) Pub. No.: US 2010/0057926 A1
(43) Pub. Date: Mar. 4, 2010

(54) DIGITAL CUSTOM DATA CONTENT INJECTION MECHANISM FOR A CONTENT DELIVERY NETWORK

(75) Inventors: Yang CAO, Westford, MA (US); Michael NICOLAZZO, Philadelphia, PA (US); William M. TURNER, Higganum, CT (US); Talbot HACK, Ann Arbor, MI (US); Moshe SUBERRI, Voorhees, NJ (US)

Correspondence Address: LAHIVE & COCKFIELD, LLP;FLOOR 30, SUITE 3000, ONE POST OFFICE SQUARE, BOSTON, MA, 02109, US

(73) Assignee: SYCAMORE NETWORKS, INC., Chelmsford, MA (US)

(21) Appl. No.: 12/200,304

(22) Filed: Aug. 28, 2008

(51) Int. Cl. G06F 15/16

(52) U.S. Cl. 709/231

(57) ABSTRACT

A content selection and injection mechanism is provided for a communication network. In the communication network, an electronic device inserts custom data content into a data stream. The electronic device accepts a data stream from a location in the access network and identifies an insertion point suitable for inserting the custom data content into the data stream. The electronic device also selects the custom data content from a local content storage repository located in the access network, and inserts the custom data content into the data stream at the identified insertion point. The electronic device may identify a targeted user for receiving content, and select the custom data content based on the identity of the targeted user.

### BACKGROUND

A communication network typically includes a core network and at least one access network. The core network is the central part of the communication network and serves as the backbone of the communication network. The core network typically includes high capacity switches and transmission equipment. Each access network serves as the point of contact with the communication network for users. Access networks connect subscribers with their service providers. A communication network may have multiple access networks, serving different sets of users, in communication with a single core network.

A communication network may deliver content to a user. Typically, a user device in an access network will create a request for a certain piece of content, and forward that request through the access network to the core network. A core services platform, which is a device located in the core network that performs a variety of services, may identify a location where the requested content is stored. Typically, this location is a content storage repository. The content storage repository may be located in the same access network as the user, in a different access network, or in the core network. The core services platform then may coordinate the retrieval of the requested content from the content storage repository, and may coordinate the delivery of the requested content back to the user device.

One additional use for communication networks is the delivery of custom content, such as advertising, to a user. When a user device requests content, further custom content is sent to the user device in addition to the requested content. This custom content may be stored in the core network or an access network. The custom content may or may not reside in the same content storage repository as the requested content. Locating and coordinating the delivery of this custom content is a task also typically performed by the core network.

This additional functionality increases the burden on the core network. Even if not stored in the core network, the content will likely need to pass through the core network on its way to the user, requiring increased bandwidth through the core. Further, users (and custom content providers) increasingly make use of interactive and streaming data, which increases the amount of data that must be stored and moved through the network in comparison to static or non-streaming data. This can be a drain on the resources of the core network. When the core network experiences heavy traffic, this can be reflected in less data throughput in each of the access networks serviced by the core, even when only one of the access networks is responsible for the increased traffic.

### SUMMARY

According to the present disclosure, a content selection and injection mechanism is provided for a communication network. In the communication network, for example, a wireless content delivery network, an electronic device inserts custom data content into a data stream. The electronic device may accept a data stream from a location in the access network and identify an insertion point suitable for inserting the custom data content into the data stream. The electronic device may also select the custom data content from a local content storage repository located in the access network, and insert the custom data content into the data stream at the identified insertion point. To facilitate custom data content insertion, the data stream may contain a placeholder object that the inserted custom data content modifies or replaces.

According to one embodiment, the electronic device may identify a targeted user for receiving content, and select the custom data content based on the identity of the targeted user. For example, the custom data content may be selected based on an affinity group of the targeted user which defines preference data for the targeted user. The content object may also be selected based on a learned historical preference of the targeted user.

According to another embodiment, the custom data content may be selected based on the geographic location of the targeted user. If the targeted user changes geographic location, the electronic device may select additional custom data content, identify a second insertion point suitable for inserting the additional custom data content into the data stream, and insert the additional custom data content object into the data stream at the second insertion point.

According to another embodiment, the data stream may be analyzed for semantic context information, and the custom data content may be selected based on the semantic context information.

The above-mentioned content selection schemes may be applied alone or in combination.

The data stream may be a media stream containing streaming video or audio. In this case, the insertion point may be a video or audio transition that defines a scene change or media object cache segment changeover. Alternatively, the insertion point may be a streaming media state change that updates a state of the media stream.

A method of inserting custom data content into a data stream, and an electronic device readable storage medium storing executable instructions for inserting custom data content into a data stream are also provided.

### BRIEF DESCRIPTION OF THE DRAWINGS

FIG. 1 depicts a communication network suitable for practicing the embodiments described herein.

FIG. 2 depicts an access network suitable for practicing the embodiments described herein.

FIG. 3 depicts an electronic device suitable for practicing the embodiments described herein.

FIG. 4 depicts an example of a data stream containing streaming video.

FIG. 5 depicts a flow chart of one embodiment of the procedures performed by the electronic device of FIG. 3.

FIG. 6 depicts data selection metrics for use in an illustrative embodiment.

### DETAILED DESCRIPTION

In view of the limited resources available in a core network, it may be beneficial to move some functionality away from the core and into the access network. Because the access network is typically located in close geographic proximity to the user, targeted data content can be provided to users in an efficient manner by utilizing the access network. Further, resources can be apportioned in the access network without diminishing the functionality of the core network. As a result, a spike in resource usage in the access network will not necessarily slow the entire core network, and, by extension, the other access networks.

Therefore, there is a need for a content selection mechanism with the capability to identify a targeted user, and select data content stored locally in the access network to be injected in user data stream. This data content may be aligned with stated individual or affinity-group preferences, semantically identified based on user data consumption elements and patterns, or selected based on the geographic location of the targeted user. Alternatively, a combination of these capabilities can be applied given the local availability and relative priority of selected data content objects.

There is also a need for a content injection mechanism located in the access network. The content injection mechanism should have the capability to identify an insertion point in a data or media stream, and insert data content in an appropriate manner.

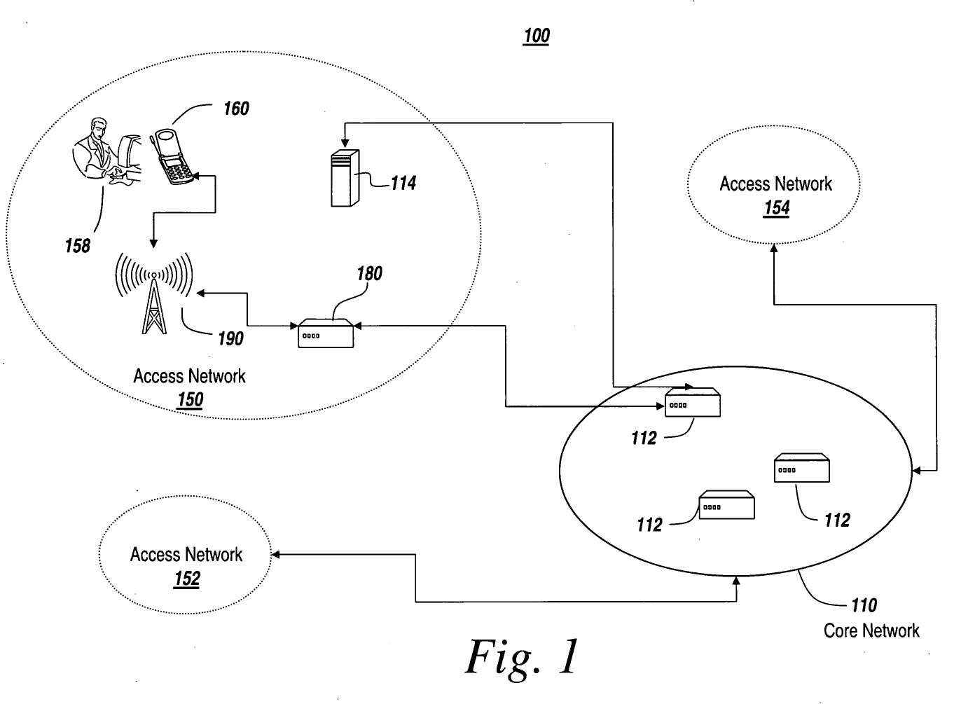

FIG. 1 depicts a communication network 100. According to one embodiment, the communication network 100 may be a wireless network, such as a mobile telecommunication network, and includes a core network 110 and access networks 150, 152 and 154. According to other embodiments, the communication network 100 may include more or fewer access networks. One skilled in the art will recognize that the functionality described herein example is equally applicable in different types of communication networks, such as a network utilizing a WiFi framework, a UTRAN or UMTS framework, a CDMA framework, a WiMax framework, or a UMB framework, among others.

Within the core network 110 may be any number of core services platforms 112, such as servers. The core services platforms 112 may provide services within the core network, such as (but not limited to) fetching data from a storage repository 114 and routing data throughout the communications network 100, and may provide an interface to back-end infrastructure (such as file servers, DNS routers, etc) to support the operation of the network 100. A cores services platform 112 can take a number of forms, depending on the services to be provided. For example, if the core services platform 112 is tasked with routing data, the core services platform 112 may be a switch or a router. If the core services platform 112 must store data, the core services platform 112 may be a server, such as a file server or a mail server. Other core services platforms include network bridges, network hubs, and repeaters.

The storage repository 114 may be located within the core network 110, or alternately may be located in an access network. The storage repository 114 may be a file server, though it may be another type of device capable of storing content, such as a personal computer.

A user 158 using a user device 160 typically interacts with an access network 150 via a communications device, such as a modem, fiber optic connection, or a transmitter and receiver for radio communication. The user device 160 may be, for example, but is not limited to, a laptop, a cellular phone, or a Global Positioning System device. The user device 160 will typically send and receive data through a base station 190 located in the access network 150. The base station 190 may be, for example, a gateway, a cell tower, a Node B, or an Enhanced Node B.

The base station may itself interact with one or more intermediate service platforms 180 located in the access network 150, or may interact directly with the core network 110. The intermediate service platforms 180 may perform tasks such as resource management, filtering, and routing. Examples of intermediate service platforms 180 include Radio Network Controllers, bridges, and routers.

When the user 158 using the user device 160 requests data, the core network may locate the requested data in a storage repository 114. Storage repository 114 may be in the user device's access network 150, or the core network 110, or in a different access network 152. Once the storage repository 114 is located, the data may be sent back to the user device 160, potentially after being routed through the core network 110.

A content provider may wish to provide custom data content to the user device 160. For example, a business owner may wish to provide advertising. Conventionally, this custom data content might be stored on a storage repository located in an access network 150 local to the user 158, in a non-local access network 152, or even potentially in the core network 110. Although the custom data content may be stored in the local access network 150, the local proximity of the requested custom data content may be unknown when it is requested. Thus, the custom data content will typically be routed through the core network 110, even if it is stored at a location near the user 158. The location and routing of the custom data content is typically performed by a core services platform 112.

An advertiser may not have information relating to the user 158. The advertiser may not know where the user is located, and may lack other information that would be useful to provide targeted, personalized advertising. Information about the user 158 may not be stored in the network; alternatively, information about the user 158 may be stored in the core network 110. Because the core network 110 must store and process information about all of the users in each access network, only a limited amount of core network resources may be dedicated to this user analysis.

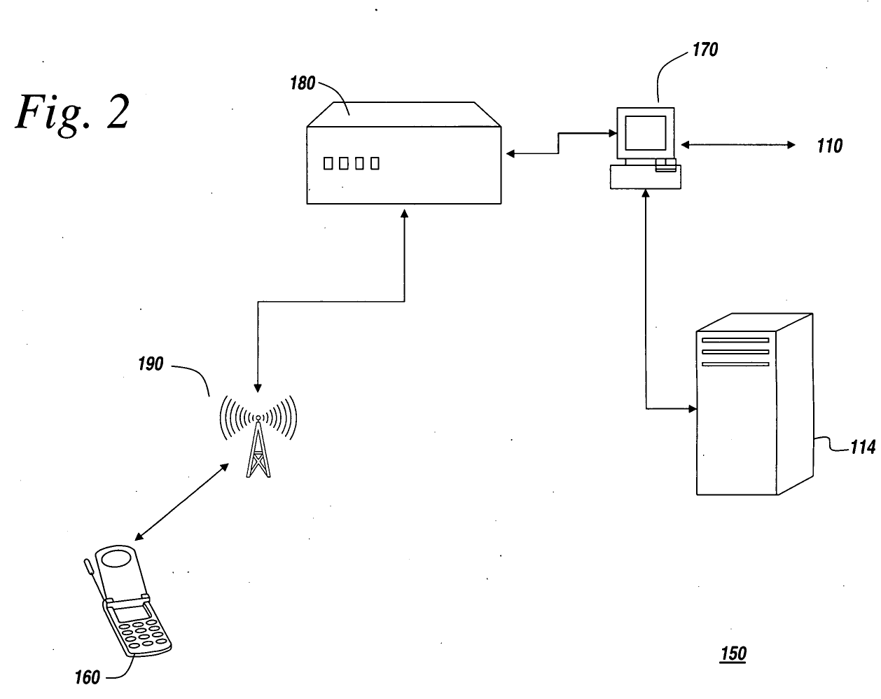

FIG. 2 depicts an access network 150 suitable for practicing the embodiments described herein. Access network 150 is the part of the communication network 100 in which a user device 160 is located. Each access network serves as the point of contact with the communication network for users, and connect subscribers with their service providers. A communication network may have multiple access networks, serving different sets of users, in communication with a single core network. Examples of access networks include the UMTS Terrestrial Radio Access Network (UTRAN), the GSM Radio Access Network (GRAN), and the GSM Edge Radio Access Network (GERAN).

In the access network 150, an electronic device 170 inserts custom data content into a data stream. As will be discussed in more detail below, the electronic device 170 may serve as both a content selection mechanism and a content injection mechanism. Alternatively, these responsibilities may be split into two or more separate electronic devices. Electronic device 170 may be, for example, a server or a router, or may be a custom-designed device.

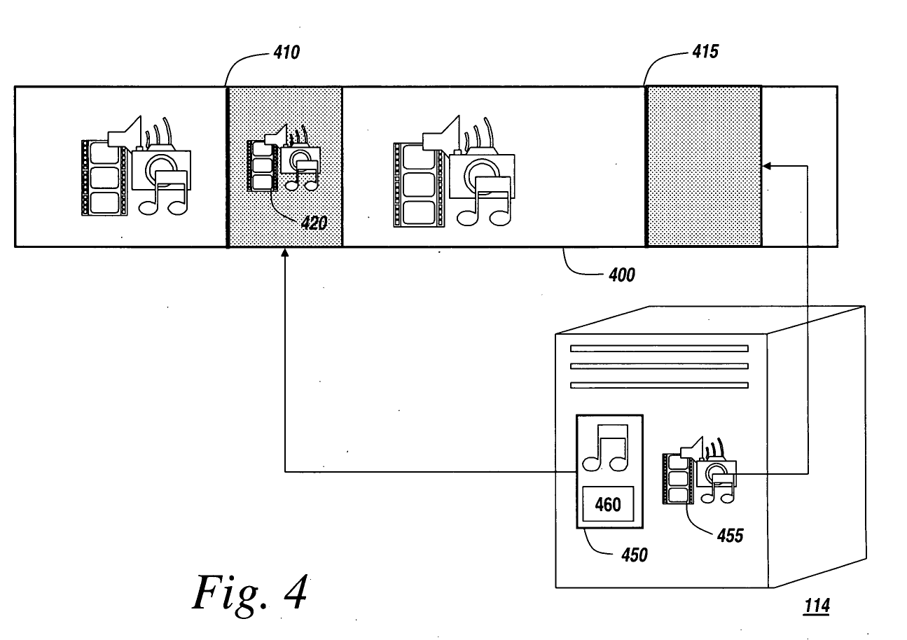

The electronic device may select custom data content 450 (depicted in FIG. 4) from a local content storage repository 114 located in the local access network 150. The storage repository may contain a variety of custom data content 450 (depicted in FIG. 4) for insertion into the data stream. The storage repository 114 and the electronic device 170 may be the same device, or they may be two different devices.

More than one custom data content object may be selected for delivery to user. In this case, content injection priority may be determined either by the electronic device 170, or by the user's local system configuration. The content selection mechanism will be discussed in more detail below.

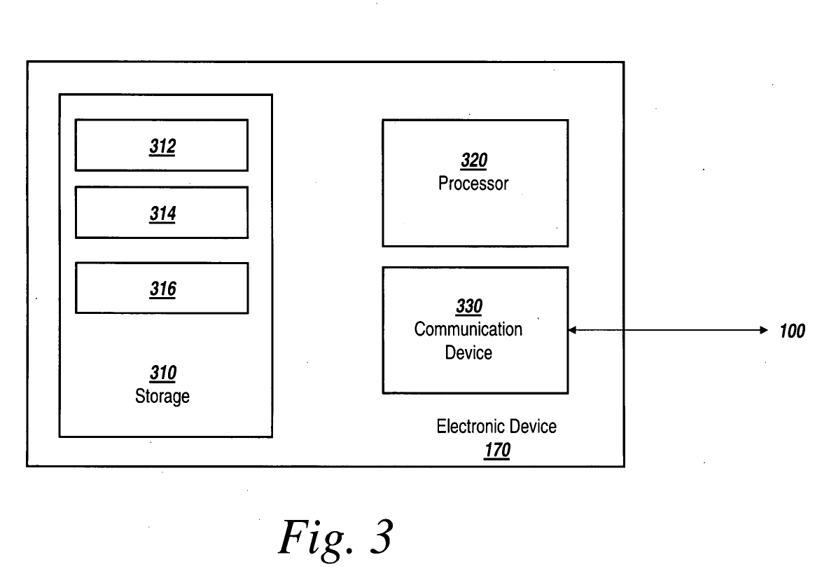

FIG. 3 depicts an example of an electronic device 170 suitable for practicing the embodiments described herein. As noted above, the electronic device 170 may be, for example, a server or a router, or may be a custom-designed device. The electronic device 170 may contain a storage 310 for storing instructions 312 to be executed by a processor 320. The storage 310 may be any type of recording media, such as RAM, ROM, magnetic storage, or optical storage. The storage 310 may also store an operating system 314 for operating the electronic device 170. The storage 310 may store additional applications 316 for providing additional functionality.

The electronic device 170 may have a communication device 330 for communicating with a communication network 100. The communication device 330 may be, for example, a modem, an Ethernet connection, a fiber optic connection, a radio antenna, or any suitable means for communicating with a network.

The electronic device 170 may proxy a transport protocol in the access network 150. For example, if the network is a UMTS network, the electronic device 170 may proxy an Iu-B or an Iu-PS protocol. However, the present disclosure is not limited to implementation in a UMTS network, and may be deployed in any suitable communication network. The transport protocol employed will vary based on the type of communication network utilized.

FIG. 4 depicts an exemplary data stream 400, which may be routed through the communication network 100. In addition to serving as a content selection mechanism, the electronic device 170 may also function as a content injection mechanism. In this capacity, the electronic device 170 accepts the data stream 400 at a location in the access network 150. The electronic device 170 identifies an insertion point 410 suitable for inserting the custom data content 450 into the data stream 400, and inserts the custom data content 450 into the data stream 400 at the identified insertion point 410. This content-injection mechanism will be discussed in more detail below.

To facilitate custom data content insertion, the data stream may contain a placeholder object 420 that the inserted custom data content modifies or replaces. This allows custom data content to substitute for non-custom data content. However, such a placeholder is not a requirement, and the electronic device 170 may insert custom data content into a data stream at an insertion point containing existing non-placeholder media, or no media at all. This allows data content to be added to a data stream.

The data stream 400 may be a media stream containing streaming video or audio, and may be consistent with endpoint session media descriptors. The media stream may utilize a media transport mechanism such as RTP, RTSP, or HTTP. Depending on the type of media stream, other media transport mechanisms may be utilized.

If the data stream is a media stream, the insertion point 410 may be a video or audio transition that defines a scene change or media object cache segment changeover. The electronic device 170 may identify a scene change or media object cache segment changeover in the media stream by analyzing the media stream and determining when such a change takes place. Alternately, the media stream or another device may indicate when such a change occurs.

Alternatively, the insertion point 410 may be a streaming media state change that updates a state of the media stream. For example, if the user 158 is watching streaming video on the user device 160, and subsequently presses the “stop,” “pause,” or “play” button, this may indicate a change in the state of the media stream. At this point, the electronic device 170 may identify this point in the media stream as an insertion point 410 and may insert custom data content 450 at the insertion point 410.

The data stream 400 may also contain structured format data objects, such as HTML pages. In this case, the electronic device 170 may insert custom data content 450 within the structured format data objects dynamically. Alternatively, if the data stream contains structured text object elements, the electronic device may insert the custom data content 450 as defined within the structured text object elements statically.

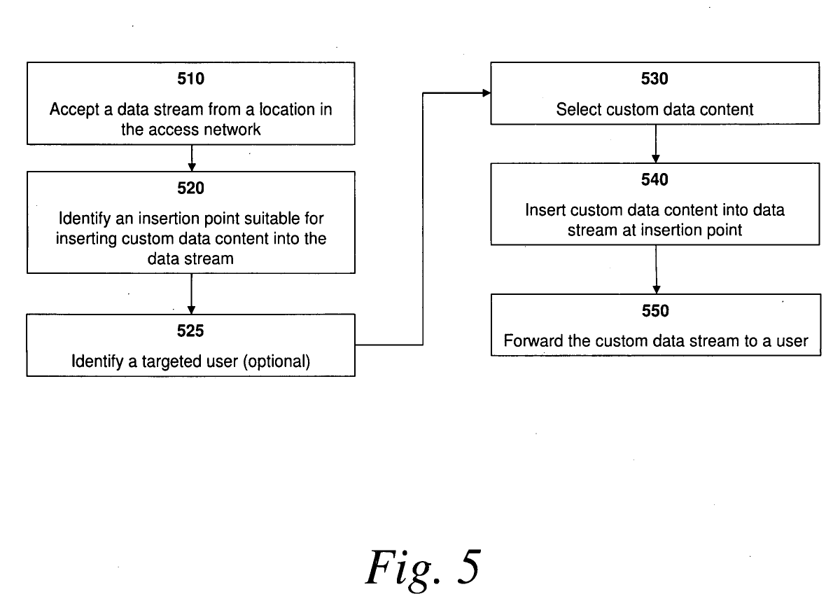

FIG. 5 depicts a flowchart of procedures that may be carried out by electronic device 170. According to one embodiment, the storage 310 of electronic device 170 may store executable instructions 312 for inserting custom data content 450 into a data stream 400 in the communication network 100 (see FIG. 4). At step 510, the instructions 312 may cause the processor 320 to accept a data stream 400 from a location in the access network 150. Step 510 may involve intercepting a data stream 400 present in the access network 150, where the data stream 400 is bound for location in the access network 150 or the core network 110. For example, electronic device 170 may intercept a data stream 400 destined for user device 158, after data stream 400 was sent from a core services platform 112. Alternatively, step 510 may simply involve receiving a data stream 400 which has been routed specifically to electronic device 170.

At step 520, the instructions 312 cause the processor 320 to identify an insertion point 410 suitable for inserting the custom data content 450 into the data stream 400.

At step 530, the instructions 312 cause the processor 320 to select the custom data content 450 from a local content storage repository 114 located in the access network 150, and at step 540, the instructions 312 cause the processor 320 to insert the custom data content 450 into the data stream 410 at the identified insertion point. After the custom data content 450 has been inserted into the data stream 410, the data stream becomes a custom data stream. At step 550, the custom data stream, including the custom data content 450, may be forwarded to a user.

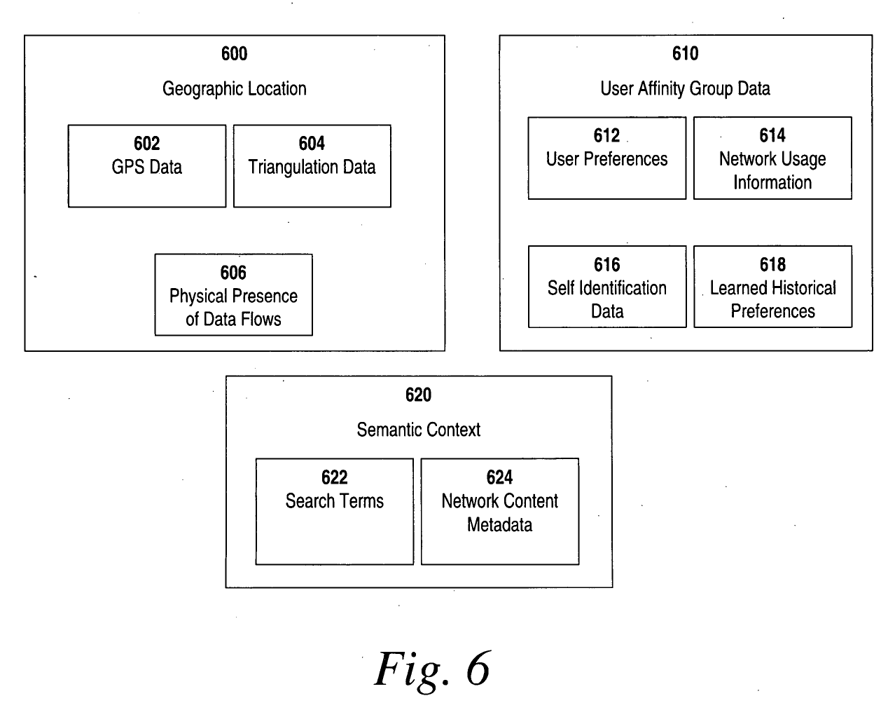

According to one embodiment, the electronic device 170 may, at step 525, identify a user 158 (a “targeted user”) for receiving content. If a user 158 is identified, the electronic device 170 may, at step 530, select the custom data content 450 based on the data selection metrics relating to the identity of the user 158. FIG. 6 depicts several data selection metrics. For example, the custom data content 450 may be selected based on an affinity group 610 of the targeted user 158. An affinity group 610 defines preference data for the user 158. For example, one user might have an affinity group of “boating enthusiast,” and might be served custom data content related to boating, yachting, or watersports. A user 158 may belong to one or more affinity groups.

Affinity group data may be obtained and stored at the electronic device 170, or either of these functions may be carried out by a different device. User affinity groups may be determined by analyzing user preferences 612 and network usage information 614, or the user may self-identify 616 with certain affinity groups. Affinity group data may be well-defined and structured to enable a strong and unambiguous association with locally deployed custom data content. Injected content metadata 460 may identify a classification that provides an association with user- and affinity-group preferences. Injected content may have multiple classifications to provide better or broader coverage. Delivery metrics may be obtained for each user to provide history and custom data content selection refinement based on what custom data content proves to be of interest to a user. In this way, the custom data content 450 may be selected based on a learned historical preference 618 of the targeted user.

As an alternative or a supplement to affinity group data, the custom data content 450 may be selected based on the geographic location 600 of the targeted user. Such a geographic location may be determined by a number of means, such as the Global Positioning System data 602, or triangulation 604 based on the signal strength of the user device 160. Geographic location may also be determined by the physical presence of data flows 606 in an access network. Local substitution may be performed by the electronic device 170. Thus, a mobile or stationary user may receive targeted custom data content relating to the geographic area that they are in. If custom data content is not available for the local area, a default selection may be made from an upstream origin source to provide non-geographic default content.

If the targeted user changes geographic location, the electronic device 170 may select additional custom data content 455, identify a second insertion point 415 suitable for inserting the additional custom data content 455 into the data stream 400, and insert the additional custom data content 455 into the data stream 400 at the second insertion point 415. The second insertion point could be the same as, or different than, the first insertion point. In this way, as a mobile user traverses between different locations in the same access network, or different access networks, injected content sent into the user's data flow may change as different local references are selected.

The data stream 400 may also be analyzed for semantic context information 620, and the custom data content may be selected based, totally or in part, on the semantic context information. Semantic context information 620 might include a number of data points, such as search terms 622 or network content metadata 624. This analysis may allow the electronic device 170 to provide context-driven custom data content. A mapping of custom data content classifications to broad context definitions may enable a coupling of user experience to selected custom data content. Additional granularity in the semantic context classification mapping may result in more targeted custom data content selection.

Because electronic device 170 is located in the access network 150, rather than the core network 110, custom data content can be provided at a location closer to a user 158. Further, resources at the network core 110 are freed to perform other tasks. With the systems and methods described herein, more information can be collected and stored about a user 158, thus resulting in a better selection of customized data content.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the invention, and exclusive use of all modifications that come within the scope of the appended claims is reserved. It is intended that the present invention be limited only to the extent required by the appended claims and the applicable rules of law.

1. An electronic device readable storage medium storing executable instructions for inserting custom data content into a data stream in a communication network, the communication network comprising an access network, the instructions causing a processor to:
intercept a data stream in the access network;
identify an insertion point suitable for inserting the custom data content into the data stream;
select the custom data content from a local content storage repository located in the access network;
insert the custom data content into the data stream at the identified insertion point to create a custom data stream; and
forward the custom data stream to a user.

2. The medium of claim 1, further comprising instructions that, when executed by the processor, cause the processor to:
identify a targeted user for receiving content; and
select the custom data content based on the identity of the targeted user.

3. The medium of claim 2, wherein the custom data content is selected based on the geographic location of the targeted user.

4. The medium of claim 3, further comprising instructions to cause the processor to:
select additional custom data content when the geographic location of the targeted user changes;
identify a second insertion point suitable for inserting the additional custom data content into the data stream; and
insert the additional custom data content object into the data stream at the second insertion point.

5. The medium of claim 2, wherein the custom data content is selected based on an affinity group of the targeted user, the affinity group of the targeted user defining preference data for the targeted user.

6. The medium of claim 2, wherein the data stream is analyzed for semantic context information, and the custom data content is selected based on the semantic context information.

7. The medium of claim 1, wherein:
the data stream is a media stream containing streaming video or audio; and
the insertion point is a video or audio transition that defines a scene change or media object cache segment changeover.

8. The medium of claim 1, wherein:
the data stream is a media stream containing streaming video or audio; and
the insertion point is a streaming media state change that updates a state of the media stream.

9. The medium of claim 1, wherein the data stream contains a placeholder object, and the inserted custom data content modifies or replaces the placeholder object in the data stream.

10. The medium of claim 1, wherein the content object is selected based on a learned historical preference of the targeted user.

11. The medium of claim 1, wherein the communication network is a mobile telecommunication network.

12. A method in an electronic device for inserting custom data content into a data stream in a communication network, the communication network comprising an access network, the method comprising:
intercepting a data stream in the access network;
identifying an insertion point suitable for inserting the custom data content into the data stream;
selecting the custom data content from a local content storage repository located in the access network;
inserting the custom data content into the data stream at the identified insertion point to create a custom data stream; and
forward the custom data stream to a user.

13. The method of claim 12, further comprising:
identifying a targeted user for receiving content; and
selecting the content object based on the identity of the targeted user.

14. The method of claim 13, wherein the custom data content is selected based on the geographic location of the targeted user.

15. The method of claim 14, further comprising:
selecting additional custom data content when the geographic location of the targeted user changes;
identifying a second insertion point suitable for inserting the additional custom data content into the data stream; and
inserting the additional custom data content object into the data stream at the second insertion point.

16. The method of claim 13, wherein the custom data content is selected based on an affinity group of the targeted user, the affinity group of the targeted user defining preference data for the targeted user.

17. The method of claim 13, wherein the data stream is analyzed for semantic context information, and the custom data content is selected based on the semantic context information.

18. The method of claim 12, wherein:
the data stream is a media stream containing streaming video or audio; and
the insertion point is a video or audio transition that defines a scene change or media object cache segment changeover.

19. The method of claim 12, wherein:
the data stream is a media stream containing streaming video or audio; and
the insertion point is a streaming media state change that updates a state of the media stream.

20. The method of claim 12, wherein the data stream contains a placeholder object, and the inserted custom data content modifies or replaces the placeholder object in the data stream.

21. The method of claim 12, wherein the content object is selected based on a learned historical preference of the targeted user.

22. The method of claim 12, wherein the communication network is a mobile telecommunication network.

23. An electronic device for inserting custom data content into a data stream in a communication network, the communication network comprising an access network, the electronic device comprising:
a storage located in the access network for storing local content; and
a processor located in the access network for executing instructions, the instructions causing the processor to:
proxy a network transport protocol;
intercept a data stream in the access network;
identify an insertion point suitable for inserting the custom data content into the data stream;
select the custom data content from among the local content in the storage; and
insert the custom data content into the data stream at the identified insertion point.

24. The electronic device of claim 23, further comprising instructions to:
identify a targeted user for receiving content; and
select the content object based on the identity of the targeted user.

25. The electronic device of claim 24, wherein the custom data content is selected based on the geographic location of the targeted user.

26. The electronic device of claim 25, further comprising instructions to:
select additional custom data content when the geographic location of the targeted user changes;
identify a second insertion point suitable for inserting the additional custom data content into the data stream; and
insert the additional custom data content object into the data stream at the second insertion point.

27. The electronic device of claim 24, wherein the custom data content is selected based on an affinity group of the targeted user, the affinity group of the targeted user defining preference data for the targeted user.

28. The electronic device of claim 24, wherein the data stream is analyzed for semantic context information, and the custom data content is selected based on the semantic context information.

29. The electronic device of claim 23, wherein:
the data stream is a media stream containing streaming video or audio; and
the insertion point is a video or audio transition that defines a scene change or media object cache segment changeover.

30. The electronic device of claim 23, wherein:
the data stream is a media stream containing streaming video or audio; and
the insertion point is a streaming media state change that updates a state of the media stream.

31. The electronic device of claim 23, wherein the data stream contains a placeholder object, and the inserted custom data content modifies or replaces the placeholder object in the data stream.

32. The electronic device of claim 23, wherein the content object is selected based on a learned historical preference of the targeted user.

33. The electronic device of claim 23, wherein the communication network is a mobile telecommunication network.
